(19) United States
(12) Patent Application Publication
(10) Pub. No.: US 2024/0193198 A1
(43) Pub. Date: Jun. 13, 2024

(54) QUERY PROCESSING AND VISUALIZATION APPARATUSES, METHODS AND SYSTEMS

(71) Applicant: LEO Technologies, LLC, Austin, TX (US)

(72) Inventors: Aslam Karamath Tajwala, Irvine, CA (US); Timothy Ray Anderson, Foothill Ranch, CA (US); James McAbee Sexton, Los Angeles, CA (US)

(21) Appl. No.: 18/078,034

(22) Filed: Dec. 8, 2022

(51) Int. Cl. G06F 16/338; G06F 16/31

(52) U.S. Cl. CPC G06F 16/338; G06F 16/31; G06F 16/316

(57) ABSTRACT

The QUERY PROCESSING AND VISUALIZATION APPARATUSES, METHODS AND SYSTEMS (“QPAV”) provides a platform that, in various embodiments, is configurable to receive, evaluate, and respond to queries over collections of structured and unstructured data, such as call records having associated metadata. Implementations provide for the generation of graphical representations of call networks, comprising nodes and links, in response to a received query which may comprise terms spoken in one or more call transcripts. The visual representation of query results may be enhanced by metadata, and may be configurable by the user to highlight particular connections, behaviors, or other insights associated with callers in the network.

This patent application disclosure document (hereinafter “description” and/or “descriptions”) describes inventive aspects directed at various novel innovations (hereinafter “innovation,” “innovations,” and/or “innovation(s)”) and contains material that is subject to copyright, mask work, and/or other intellectual property protection. The respective owners of such intellectual property have no objection to the facsimile reproduction of the patent disclosure document by anyone as it appears in published Patent Office file/records, but otherwise reserve all rights.

### FIELD

The present inventions are directed generally to apparatuses, methods, and systems for efficient data collection, storage, and evaluation, and more particularly, to QUERY PROCESSING AND VISUALIZATION APPARATUSES, METHODS AND SYSTEMS (“QPAV”).

### BACKGROUND

Ubiquitous electronic communications have resulted in large volumes of information being generated and stored. Modern computing technologies facilitate the collection and processing of such large amounts of data, such as to facilitate searching or other analysis.

### BRIEF DESCRIPTION OF THE DRAWINGS

The accompanying appendices and/or drawings illustrate various non-limiting, example, inventive aspects in accordance with the present disclosure:

FIG. 1 shows an implementation of logic flow for call information collection and index creation in some embodiments of the QPAV;

FIG. 2 shows an implementation of logic flow for query building, query execution, and link-data enrichment, in some embodiments of the QPAV;

FIGS. 3A-3B show implementations of graphs comprising nodes and links associated with phone calls in some embodiments of the QPAV;

FIG. 4 shows an implementation of a graph comprising a plurality of nodes and links in a network configuration in some embodiments of the QPAV;

FIG. 5 shows an implementation of a graph with variable link thickness in some embodiments of the QPAV;

FIG. 6 shows an implementation of a graph with node combining in some embodiments of the QPAV;

FIGS. 7A-7B shows an implementation of path-finding in a graph with node combining in some embodiments of the QPAV;

FIG. 8A shows an implementation of a degrees view for a graph in some embodiments of the QPAV;

FIG. 8B shows an implementation of a betweenness view for a graph in some embodiments of the QPAV;

FIG. 8C shows an implementation of a closeness view for a graph in some embodiments of the QPAV;

FIG. 8D shows an implementation of a pagerank view for a graph in some embodiments of the QPAV;

FIG. 8E shows an implementation of a popularity view for a graph in some embodiments of the QPAV;

FIG. 8F shows an implementation of an organic view for a graph in some embodiments of the QPAV;

FIG. 8G shows an implementation of a lens view for a graph in some embodiments of the QPAV;

FIG. 8H shows an implementation of a structural view for a graph in some embodiments of the QPAV;

FIG. 8I shows an implementation of a nested view for a graph in some embodiments of the QPAV;

FIG. 8J shows an implementation of a nested view for a graph with all links shown in some embodiments of the QPAV;

FIG. 8K shows an implementation of a nested view for a graph with selected node in some embodiments of the QPAV;

FIGS. 9A-9B shows an implementation of a QPAV dashboard user interface in some embodiments of the QPAV; and

FIG. 10 shows a block diagram illustrating embodiments of a QPAV controller.

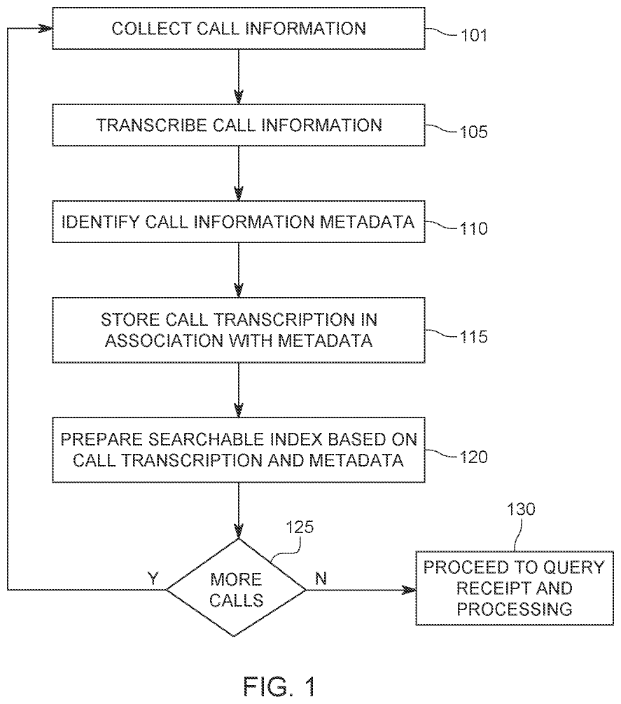

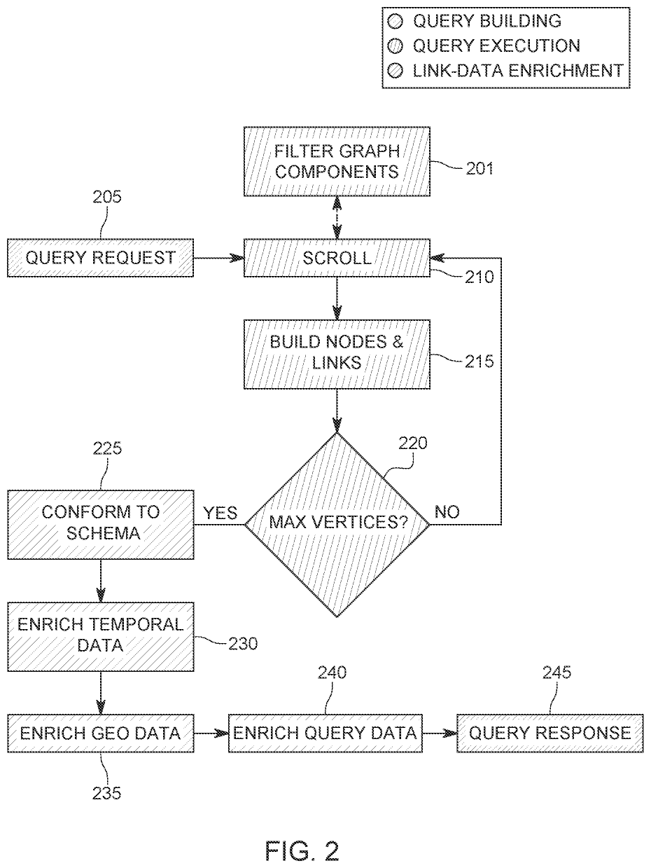

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Query Processing and Visualization (QPAV)

The QUERY PROCESSING AND VISUALIZATION APPARATUSES, METHODS AND SYSTEMS (hereinafter “QPAV”) provides a platform that, in various embodiments, is configurable to receive, evaluate, and respond to queries over collections of structured and unstructured data, such as call records having associated metadata. Implementations provide for the generation of graphical representations of call networks, comprising nodes and links, in response to a received query which may comprise terms spoken in one or more call transcripts. The visual representation of query results may be enhanced by metadata, and may be configurable by the user to highlight particular connections, behaviors, or other insights associated with callers in the network. For example, the QPAV may be employed to identify subsets of callers in a network using a particular term or collection of terms and/or discussing particular topics, and to highlight connections between the callers in order to gain insight into caller activities and behaviors.

This may be utilized, for example, in the context of law enforcement to gain insight into criminal activity and the networks of individuals engaged therewith. Modern law enforcement relies on quality data insight. This can be challenging in view of overwhelmingly large data volumes and/or a shortage of trained data analysts. Consequently, connections of interest between particular individuals may be missed, and opportunities to detect, solve, and/or prevent crimes may be lost. Embodiments of the QPAV may provide for users to perform “knowledge discovery” amongst communication records, such as call records, utilizing the disclosed data processing and visualization techniques.

For example, Person-A may communicate with Person-B (e.g., via e-mail, chat, text, pictures, video, social media posts, telephone network, internet telephony, fax, and/or the like). Such communication may result in a single connection or link between A and B to be displayed in a graphical format. Additional communications between these parties and/or others may contribute additional nodes and/or links to the graph. In some implementations, either or both of structured data (e.g., metadata) and unstructured data (e.g., communication transcript data) may be utilized to dynamically establish connections (e.g., to create links) between call participants (e.g., corresponding to nodes) within the network. This can allow, for example, the creation of actionable graphs based on the context (e.g., terms and phrases spoken in a call) of specific communications between the parties. Thus, a QPAV user may submit a query including one or more terms that appear in transcribed communications and be presented with a graph of connected communication participants that have utilized the one or more terms during their communications. Links between participant nodes in the graph may be further enhanced according to various metadata associated with the communications between those participants (e.g., number of calls, caller location, call date and/or time, and/or the like).

Some implementations of the QPAV may utilize one or more graphical visualization user interface toolkits, such as Cambridge Intelligence's ReGraph™ UI Toolkit which utilizes KeyLines javascript library in conjunction with a React component. In other implementations, different graphical visualization user interface toolkits may be employed, such as but not limited to Cytoscape.js™, Graphviz™, Kumu.io™, and/or the like. The QPAV may implement a backend application programming interface (API) to interact with and/or utilize features of the toolkit. The API may include, for example, a Graph Database, an ElasticSearch Graph API, an ElasticSearch API, and/or the like. In some implementations, the Graph Database may facilitate storage and retrieval of highly connected data, highlighting relationships between data and providing facilities for querying large networks of data. In some implementations, an ElasticSearch Graph API may facilitate queries similar to those of Graph Database. In some implementations, an ElasticSearch API may be employed to process queries, e.g., with pre-encoded data linkages.

FIG. 1 shows an implementation of logic flow for call information collection and index creation in some embodiments of the QPAV. Call information may be collected 101, such as may include call audio and/or text information, call participant information, call time and/or location information, and/or the like. As noted previously, alternative implementations may collect other forms of communications, such as but not limited to e-mail, chat, social media posts, and/or the like. In some implementations, call information may be based on communications between correctional facility inmates and/or outside counterparties. The collection and processing of such call information may, for example, facilitate criminal investigations and/or crime prevention. In alternative implementations, the QPAV may be utilized to collect and process call information associated with call centers, customer service centers, and/or the like, such as to facilitate improved customer service, training, and/or the like. Audio content of collected call information may be transcribed to yield one or more call transcripts 105, such as using any of a variety of available speech-to-text tools (e.g., DeepSpeech, Kaldi, Julius, Wav2Letter++, OpenSeq2Seq, Fairseq, Vosk, Athena, ESPnet, and/or the like). Metadata may also be identified from collected call information 110, such as but not limited to caller names, phone numbers, status identifiers, and/or other identifiers; call and/or caller locations; call dates and/or times; call duration; billing information, and/or the like. Call transcription information may then be stored in association with metadata 115, such as in one or more database tables. A searchable index (e.g., inverted index, reverse index, forward index, and/or the like) may then be generated based on the call transcription data and/or associated metadata 120. A determination may be made as to whether additional calls are to be processed 125 and, if so, the process may return to 101. Otherwise, the system is prepared to proceed to query receipt and processing 130.

In some implementations, information on communications may be collected and an index generated based on the collected information in accordance with the disclosure of U.S. Pat. No. 10,742,799 B2, which is incorporated in its entirety herein by reference.

FIG. 2 shows an implementation of logic flow for query building, query execution, and link-data enrichment, in some embodiments of the QPAV. In some implementations, graph components may be filtered (e.g., via a user-specified search parameter which allows the user to, e.g., select the minimum size of the network they wish to search for, restrict by time range, specify one or more call participant IDs, and/or the like) 201. A user may submit a query request 205 to the backend system via an API, which extracts the search parameters and builds a query. Scrolling may be applied 210, e.g., to maintain a running tally of all search results accumulated so far and continue to paginate through all search matches until all search and/or query criteria and/or conditions are satisfied. In one implementation, evaluation of whether such criteria and/or conditions have been satisfied may include (1) matching a term and/or phrase (e.g., “gun” or “got shot”) that a user is looking for along with other call information fields (metadata); and (2) limiting the size of the graph (e.g., how much data) is provided for analysis, such as via a hardcoded “max vertices” value. A raw list of objects denoting nodes (e.g., caller identifiers) and links (e.g., call information shared between a pair of nodes) may be generated 215. A determination may be made as to whether the maximum number of vertices have been reached 220 and, if not, the process may return to scrolling 210. Otherwise, each data object from the results may be transformed to a link-data schema specified by the user interface logic 225, e.g., to facilitate display of the call graph upon receipt of an API response. For example, a link-data schema may specify that each object, piece of data, and/or the like include one inmate identifier and one receiver identifier pair. The user interface logic may then leverage the schema to stitch the network together, represent it visually, and/or the like. The data may then be enriched, such as by adding temporal 230, geographic 235, and/or query 240 information to each data object. This may, for example, facilitate the display of a graph over a timeline and/or provide the ability to group nodes via identifying features (e.g., area code, location, and/or the like) and to group graphs based on the search term and/or phrase respectively. The enhanced graph may then be provided for display via the user interface 245.

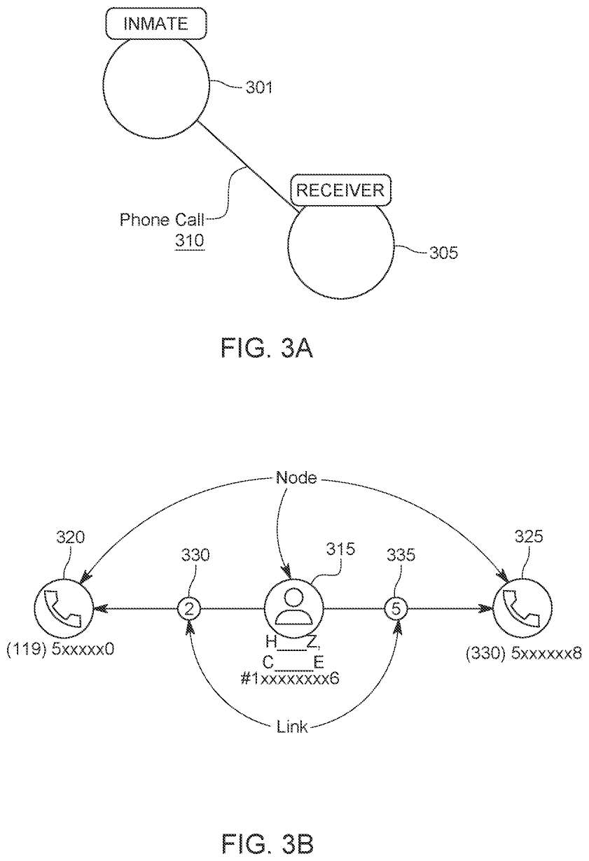

FIGS. 3A-3B show implementations of graphs comprising nodes and links associated with phone calls in some embodiments of the QPAV. FIG. 3A shows an implementation of a graph comprising two nodes and one link, wherein the nodes correspond to a correctional facility inmate 301 as a call initiator, and a receiver 305 as a call recipient, with the link connecting them corresponding to at least one phone call between the two 310 In various implementations, the at least one phone call 310 may be identified based on a query request comprising one or more query tokens corresponding to unstructured data (e.g., terms or phrases in a call transcript). FIG. 3B shows an implementation of a graph including one inmate node 315 and two receiver nodes 320, 325. In some implementations, a node may represent an inmate and/or receiver number in the network and contain properties such as, but not limited to, name, ID, telephone number, and/or the like. In some implementations, nodes may be color-coded according to the status of the call participant (e.g., inmate or receiver). For example, node 315 may be colored to indicate inmate status and include an inmate name and ID, while nodes 320 and 325 may have a different color to indicate receiver status and include a receiver phone number. The displayed graph also includes links 330, 335 representing calls between inmate 315 and receivers 320, 325 respectively. In some implementations, links may represent the connections between nodes and contain properties such as call count, direction of communication flow, originating caller, and/or the like. For example, link 330 indicates two relevant calls between inmate 315 and receiver 320, while link 335 indicates five relevant calls between inmate 315 and receiver 325. Relevance of calls and/or links may, for example, be determined based on their correspondence to one or more query tokens. In some implementations, nodes and/or links may be user-selectable in order to produce alternative graph views, provide additional information (e.g., call transcripts or excerpts, caller metadata, call time, call and/or caller location, and/or the like). For example, clicking on a node and/or link may provide an indication on a user interface timebar of when a particular call or set of calls occurred.

In some implementations, a QPAV may provide for users to “drag and drop” an entity, such as a call participant, inmate, receiver, and/or the like, into an existing Graph component for further analysis. A user may, for example, search for and drop multiple entities, causing the graph to re-render itself and display the newly added nodes and connections. In one implementation, when an inmate and/or receiver is dropped into a graph and/or a transcript search is performed, the graph component may be populated with the nodes, links and the nodes to those links. For example, by dropping an inmate, all the receivers having calls with that inmate and all inmates having calls with those receivers may be populated on the graph (e.g., a “2-Hop” searching technique). This allows the retrieval of a meaningful amount of information about the network of the call data. This may also allow for the identification of an association between two inmates via the receiver. Alternatively, a receiver may be dropped into a graph, yielding all inmates in calls with that receiver and all receivers in calls with those inmates.

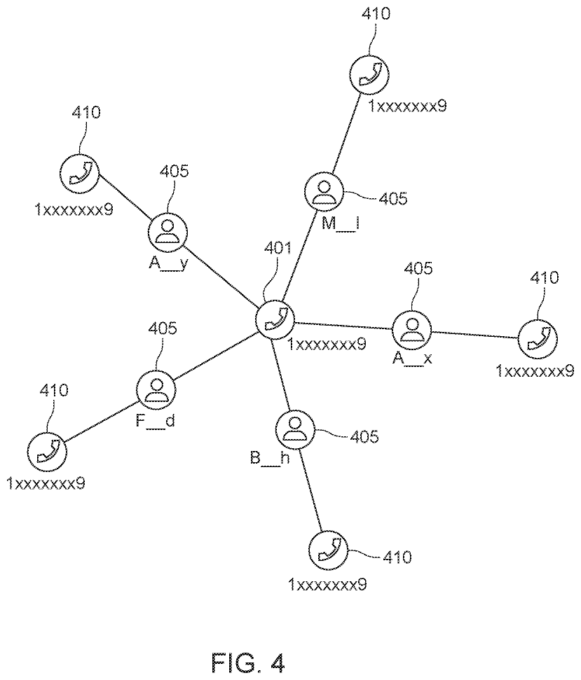

FIG. 4 shows an implementation of a graph comprising a plurality of nodes and links in a network configuration in some embodiments of the QPAV. An inmate 401 may be dropped into the display area, causing the graph to display all receivers 405 engaged in calls with that inmate, as well as all inmates 410 engaged in calls with those receivers 405.

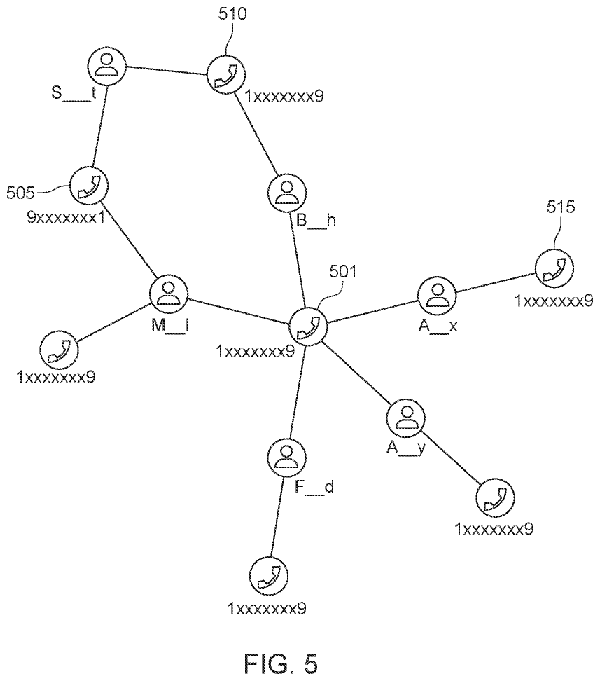

FIG. 5 shows an implementation of a graph with variable link thickness in some embodiments of the QPAV. In some implementations, dropping multiple entities may re-render a graph to show mutual connections, as shown in FIG. 5 (e.g., entities 501 and 505 being dropped, showing mutual connections as well as connections unique to each). A variable link thickness (e.g., 510 compared to 515) may also be displayed in relation to particular metadata associated with each link, such as the number of calls made between the two nodes connected by that link.

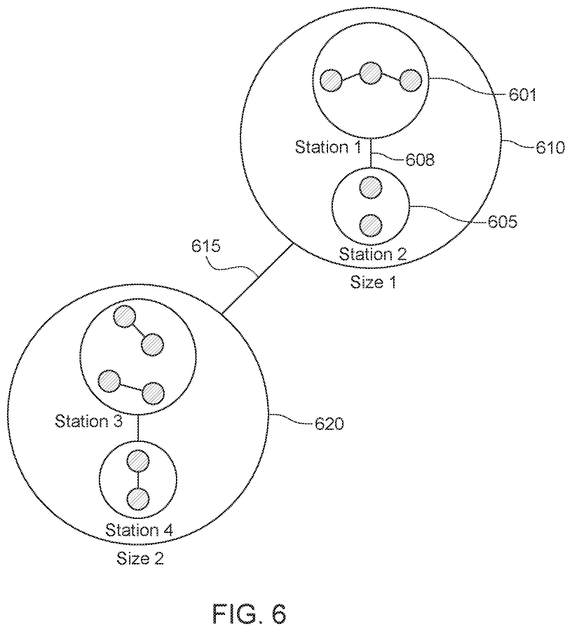

FIG. 6 shows an implementation of a graph with node combining in some embodiments of the QPAV. In one implementation, node combining may be implemented via Combos in ReGraph™. Combining nodes may, for example, reduce graph clutter (thus improving visual clarity) and/or may facilitate the identification of common aspects or relationships of nodes (e.g., location of callers). In the illustrated example, callers belonging to a first call station 601 are grouped together, while those belonging to a second call station 605 are grouped separately. A link 608 between call stations may indicate the existence of at least one call placed between stations. Station groups may then be themselves grouped by virtue of belonging to a common site 610. A link 615 may indicate one or more calls occurring between site 610 and a second site 620. In some implementations, the links for grouped callers may include 2-Hop links (e.g., a link between callers established through an intermediary receiver). In some implementations, callers and/or calls may further be grouped based on other factors, such as but not limited to call language, area code, and/or the like.

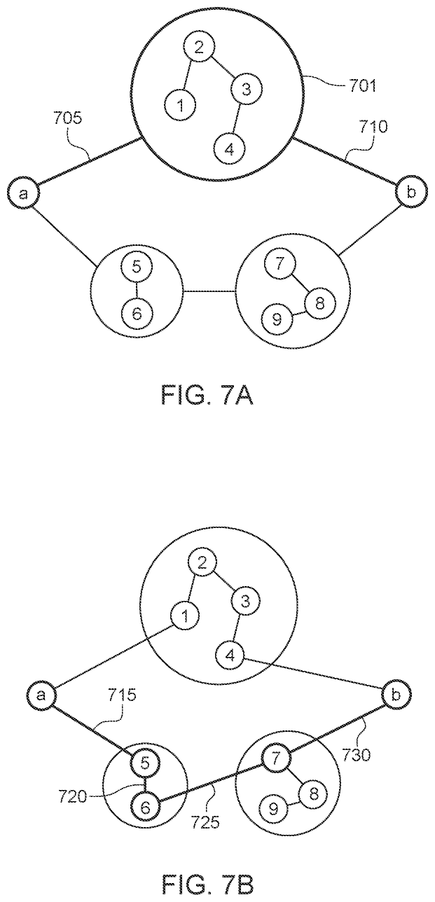

FIGS. 7A-7B shows an implementation of path-finding in a graph with node combining in some embodiments of the QPAV. In some implementations, path finding may facilitate the identification of communication flows, e.g., across different sites and/or stations. FIG. 7A shows an example with path-finding at the combo level, whereby a user is provided with a high-level view of calls made and how different sites and/or stations are clustered based on phone calls made from within (701) and across (705, 710) the cluster boundaries. FIG. 7B shows an example with path-finding at the node level, whereby a user is provided with a view showing which inmate, receiver, call, and/or the like leads to connections (715, 720, 725, 730) across the different stations and/or sites.

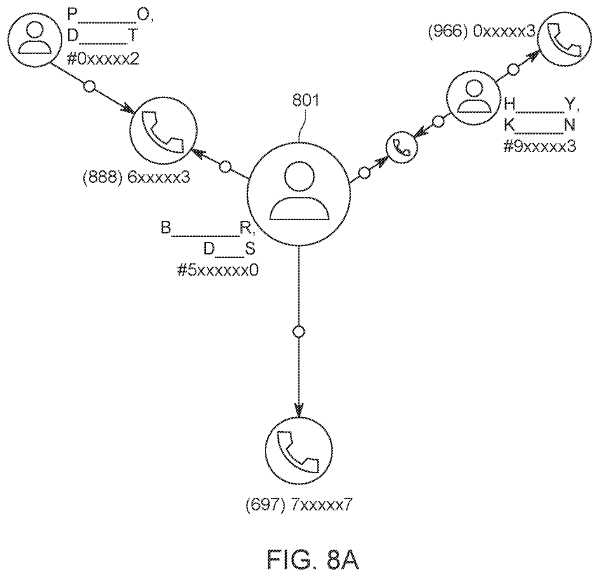

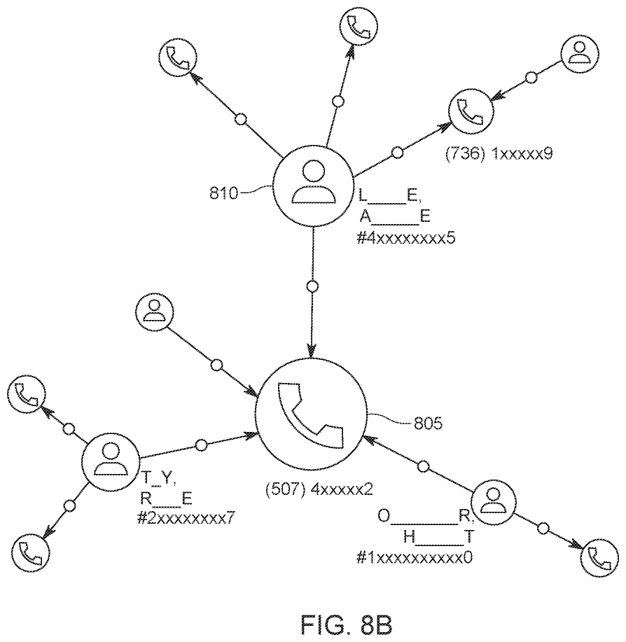

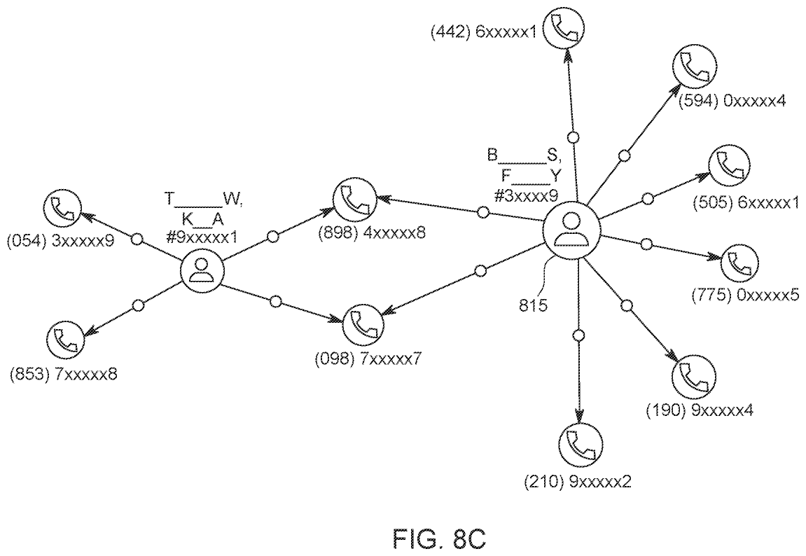

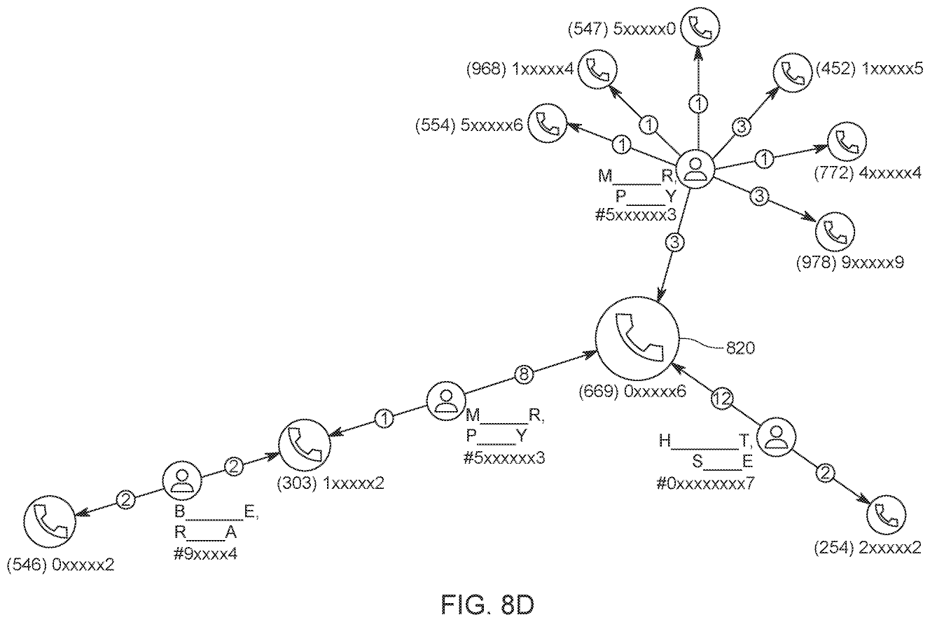

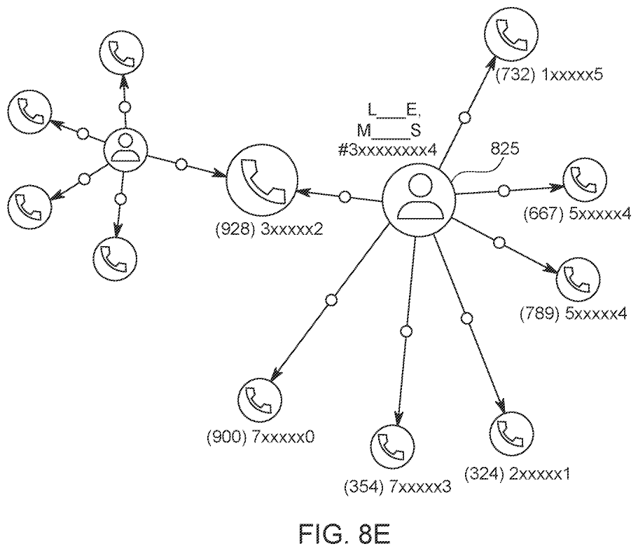

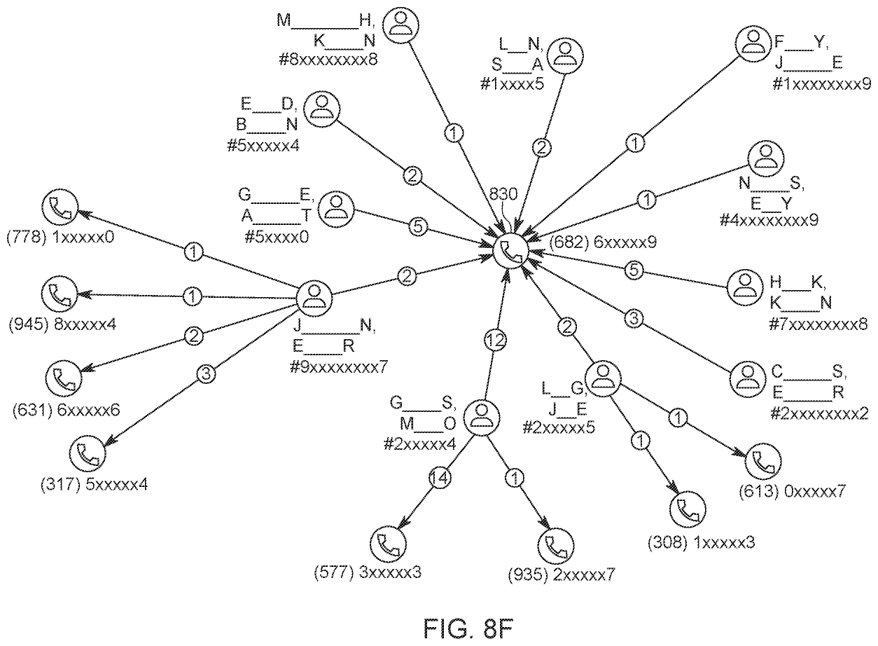

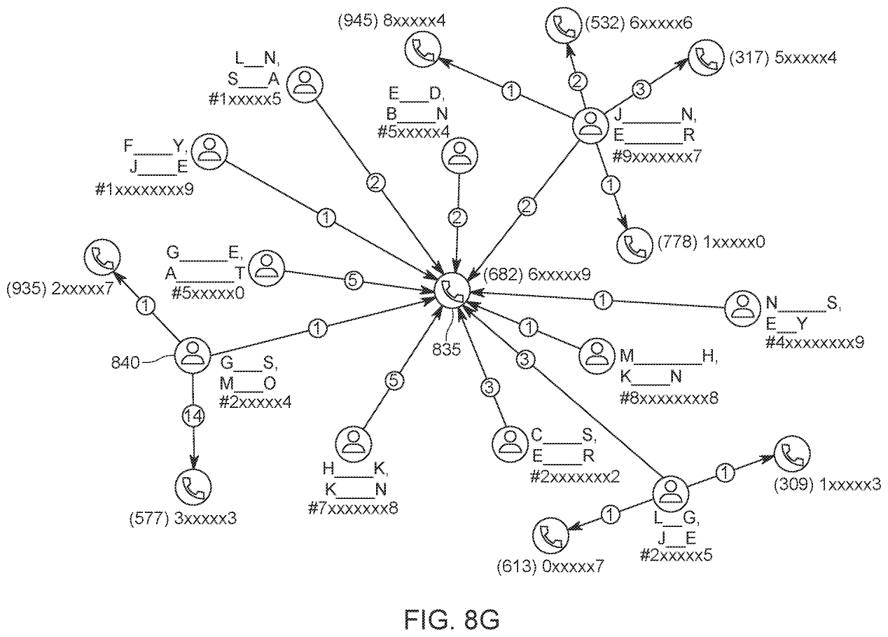

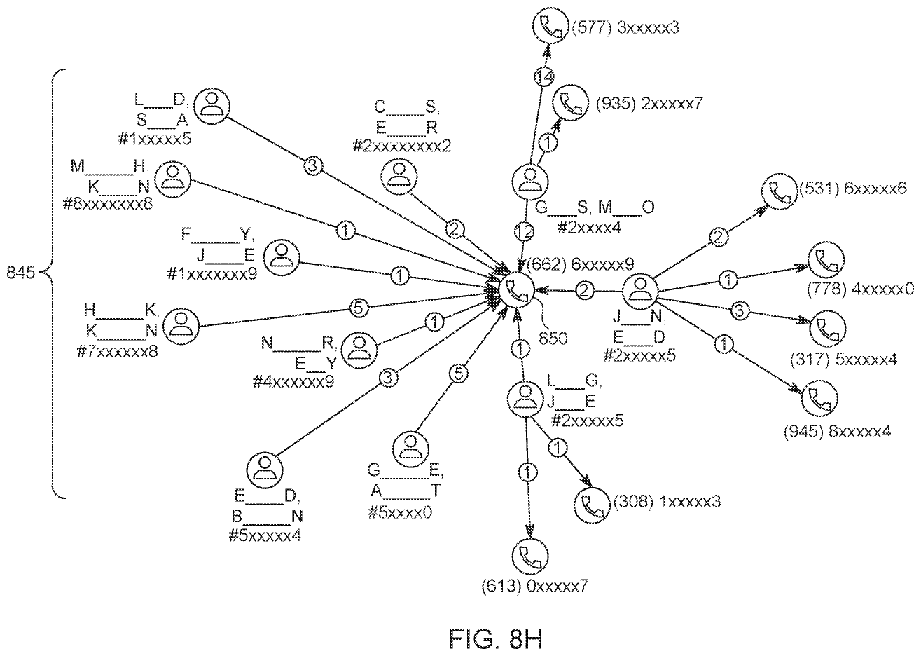

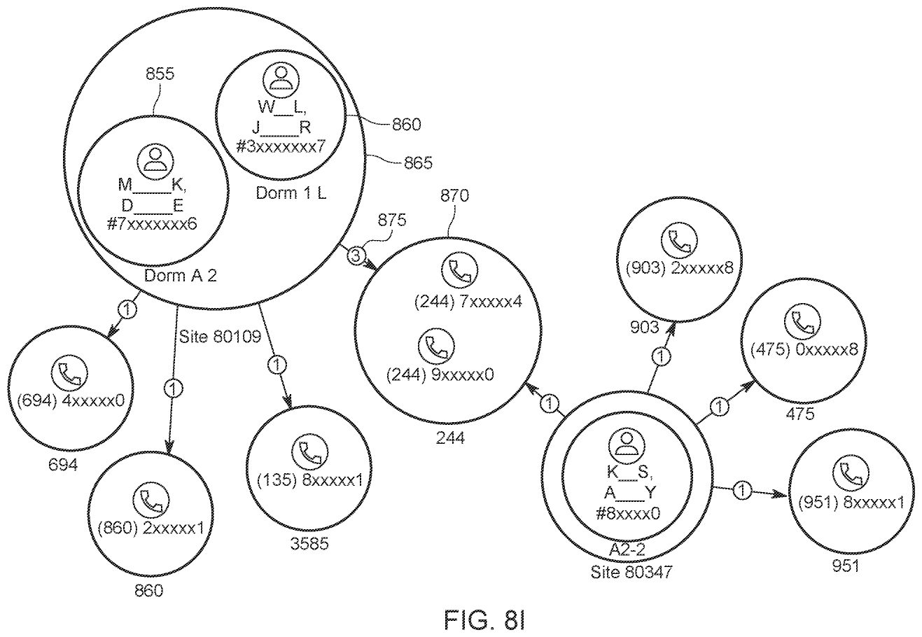

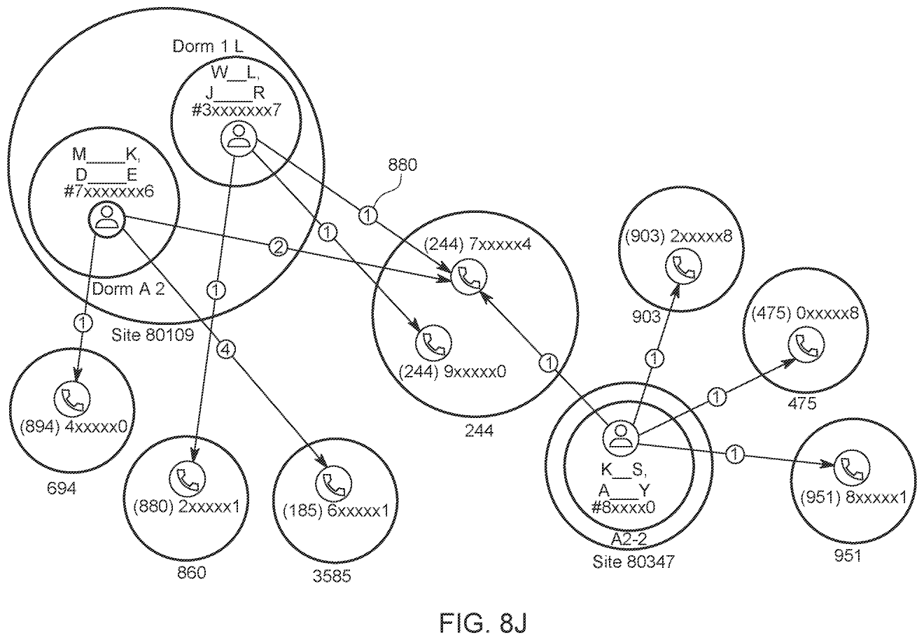

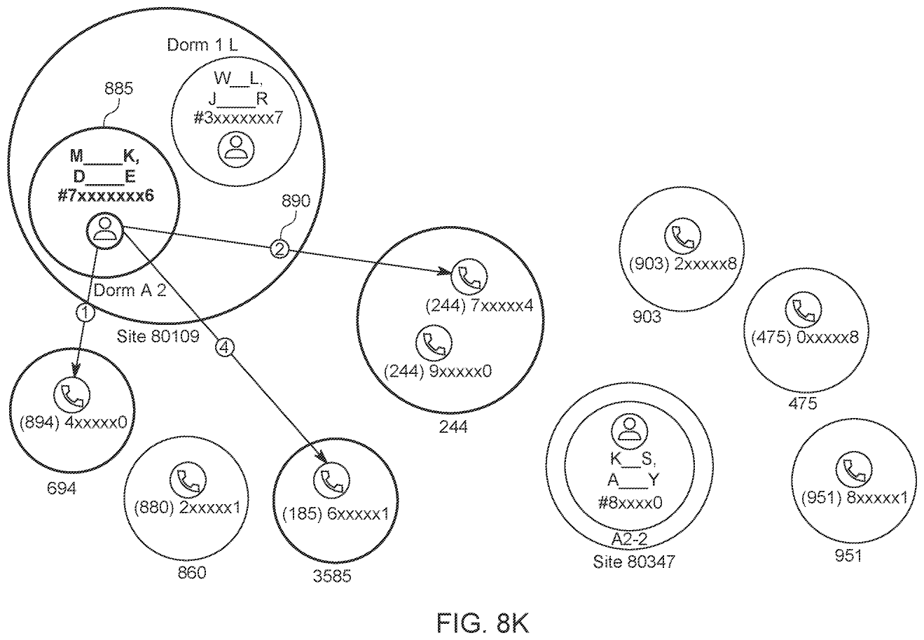

FIGS. 8A-8K show various views for graphs in embodiments of the QPAV which may, e.g., facilitate insights into how the call networks behave and may help a user to identify important nodes in a network. Selection of one or more of the graph analysis options displayed in FIGS. 8A-8K may cause, for example, the size of nodes to change to illustrate their strength or weakness relative to a given measure. In alternative implementations, a node color, highlighting, animation (e.g., flashing or flickering), and/or the like may be adjusted in response to a degree of strength relative to a given measure.

FIG. 8A shows an implementation of a degrees view for a graph in some embodiments of the QPAV. A degrees view may highlight nodes (801) with a high and/or highest number of direct connections to other nodes in the network. In one implementation, degrees may count the number of links a node has, calculate the call volume on each link to reveal the most active nodes in the network, and/or the like. In some implementations, degrees may be utilized, e.g., to find highly connected inmates and receiver numbers that have strong direct influence in the network; to identify which inmates and receiver numbers may hold the most information; to identify who can connect with the wider network quickly; to identify who has a high activity level in the network, and/or the like.

FIG. 8B shows an implementation of a betweenness view for a graph in some embodiments of the QPAV. A betweenness view may measure how often a node is found in between other nodes. This may be utilized, e.g., to help identify nodes (e.g., 805, 810) that act as communication bridges or gatekeepers in the network. Nodes with high betweenness may, for example, be more likely to control information flow and/or may become a single point of failure that breaks a communication route if they're removed from the network. In some implementations, betweenness may be utilized, e.g., to identify which individuals connect various cells in a network; to identify which inmate or receiver number would have substantial overall impact if removed from a network; and/or the like.

FIG. 8C shows an implementation of a closeness view for a graph in some embodiments of the QPAV. A closeness view may measure how close a node is to other nodes in the network. A node with a high closeness (e.g., 815) may, for example, have visibility into various communications within the network. In some implementations, closeness may be utilized, e.g., to find nodes that have quick access to other nodes in the network; to determine patient zero in an epidemic; to identify an inmate or receive number that would effectively broadcast information to many nodes in the network; and/or the like.

FIG. 8D shows an implementation of a pagerank view for a graph in some embodiments of the QPAV. PageRank may measure the importance of a node based on the number of incoming links from other important nodes. A node with high PageRank (e.g., 820) may, for example, be located in a central position in the network, may be connected to other well-connected members, and/or the like. Such a node may be significant to the network's operations and/or would break the network if it's removed. In some implementations, pagerank may be utilized, e.g., to identify who is in a position of global importance within the network.

FIG. 8E shows an implementation of a popularity view for a graph in some embodiments of the QPAV. Popularity may measure how well connected a node is, how much influence it has over other nodes in the network, and/or the like. This may be determined, e.g., by taking the centrality scores of other nodes a given node is directly connected to into account. A node with high eigenvector centrality (e.g., 825) may be at the center of a network of nodes that have high scores in other centrality measures. In some implementations, eigenvector centrality may be utilized, e.g., to find nodes with direct links to the most influential nodes in the network; to identify where groups of highly influential inmates are located; to identify key players in important networks; and/or the like.

FIG. 8F shows an implementation of an organic view for a graph in some embodiments of the QPAV. An organic view may, e.g., detangle complex networks by spreading nodes and links apart, arranging multiple components in a circular shape with larger components (e.g., 830) in the center.

FIG. 8G shows an implementation of a lens view for a graph in some embodiments of the QPAV. A lens view may arrange nodes in a circular shape with highly connected nodes (e.g., 835) set in the center and less-connected nodes (e.g., 840) in the periphery to give a ‘fish-eye lens’ view.

FIG. 8H shows an implementation of a structural view for a graph in some embodiments of the QPAV. A structural view may group nodes with similar attributes (e.g., 845) together in fans around a central node (e.g., 850) or cluster, e.g., with links evenly distributed and/or having a consistent length.

FIG. 8I shows an implementation of a nested view for a graph in some embodiments of the QPAV. In some implementations, a user may select one or more properties in order to group and/or nest nodes within the network. Such properties may include, but are not limited to, transcript search terms; location (e.g., site ID, station, and/or the like); area code; time; caller status; and/or the like. In the illustrated implementation, nodes are grouped based on (1) station (e.g., 855, 860), (2) site ID (e.g., 865), and (3) area code (e.g., 870). In some implementations, each group may be labeled according to an attribute value common to nodes in the set. The grouping function may yield a graph having summary links (e.g., 875) which may feature a label with, e.g., the number of connections in the bundle.

Alternatively, a user may select an option to show all links between groups to view and interact with individual links in a grouping. FIG. 8J shows an implementation of a nested view for a graph with all links shown in some embodiments of the QPAV. In this view, individual links (e.g., 880) between call participants within groups may be displayed. In one implementation, such individual links may feature a label with, e.g., the number of calls between corresponding nodes connected by that link.

FIG. 8K shows an implementation of a nested view for a graph with selected node in some embodiments of the QPAV. In some implementations, a particular node (e.g., 885) may be selected by a user to highlight direct connections (e.g., 890) across associated groups, gray out all other group data, and/or the like.

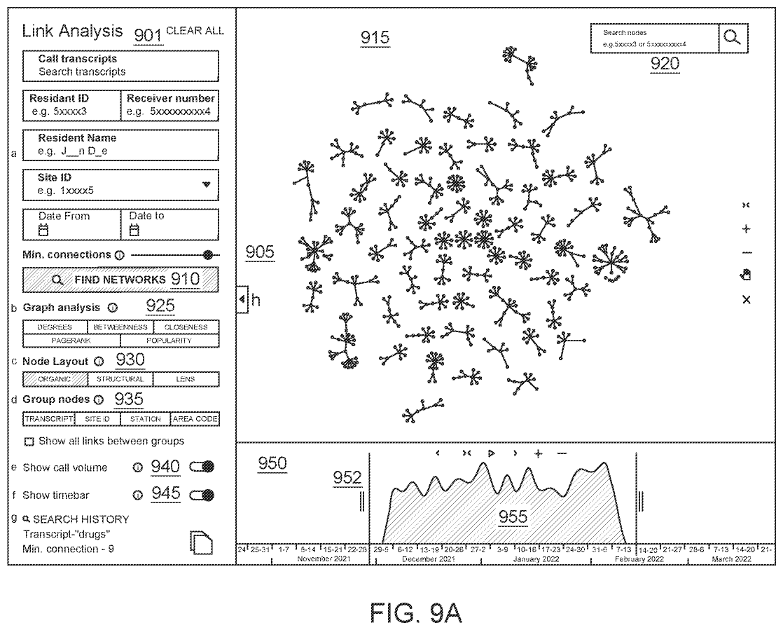

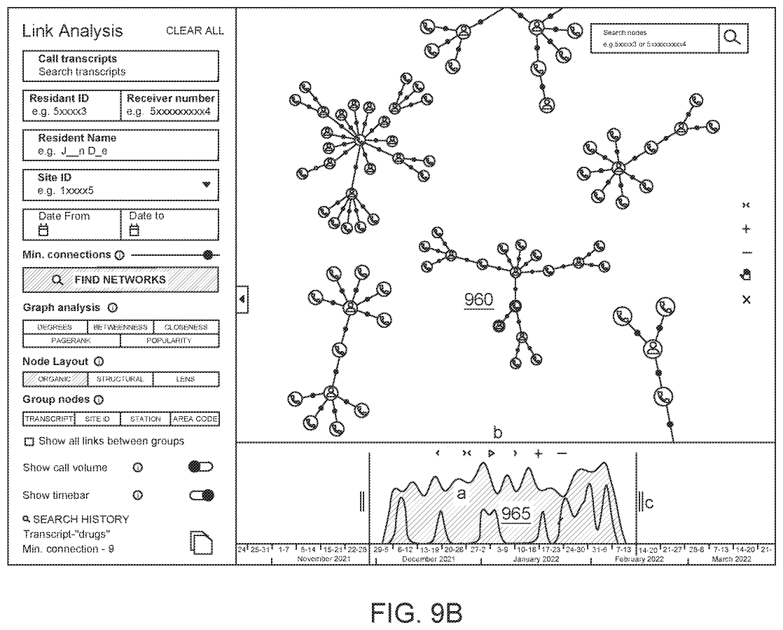

FIGS. 9A-9B shows an implementation of a QPAV dashboard user interface in some embodiments of the QPAV. In FIG. 9A, a collection of search fields 901 may facilitate the entry of query tokens corresponding to structured or unstructured data. In one example of unstructured data, keywords or phrases in a call transcript may be searched. Examples of structured data may include various forms of call metadata, such as but not limited to inmate ID; inmate number; inmate name; side ID; date from; date to; and/or the like. The interface may further include a Min connections tool (e.g., a slider) 905, allowing a user to refine a search to include nodes that have a specified minimum number of links. In one implementation, a default Min connections value (e.g., 3) may be imposed if no value is set. The user may then click a button 910 via the interface to submit the query request and retrieve graph results in a display area 915.

In some implementations, an additional search field 920 may be provided to allow for filtering of results displayed in area 915. In some implementations, the interface may further include selectable options 925 to effect different graph analysis modes, including but not limited to degrees, betweenness, closeness, pagerank, popularity, and/or the like. In some implementations, the interface may further include selectable options 930 to effect different node layouts, including but not limited to organic view, structural view, lens view, and/or the like. In some implementations, the interface may further include selectable options 935 to effect node grouping based on various criteria and/or combinations of criteria, including but not limited to transcript terms and/or phrases, site ID, station, area code, and/or the like.

In some implementations, the interface may include a selectable option 940 to display call volumes. This may allow a user to view the amount of calls occurring between different nodes in the display. A user may then be permitted to select any region of the display area 915 (e.g., by clicking and dragging a mouse to draw a box) to highlight and/or zoom in on a particular graph or graphs of interest. In some implementations, a user may add or remove individual nodes or links from a selected graph and/or group. In some implementations, links may be selected to view additional details about one or more calls, view call metadata, view call transcripts and/or excerpts thereof, and/or the like.

In some implementations, the interface may include a selectable option 945 to display a timebar 950, which may comprise an interactive interface for visualizing graph data in time. A timebar and/or regions thereof may, for example, be selectable to limit the period of interest for graphs in display area 915. For example, a time slider 952 may be utilized to select and/or limit regions of call activity displayed within the timebar. In various implementations, the timebar may be utilized to examine call activity volume over time (e.g., to identify patterns and/or trends of communications); to filter a graph to display data for a specific time range or ranges; to play a chronological sequence of call activity over a selected time period (e.g., to see how data evolved and watch networks form, change, interact, and/or the like); to see associations between selected nodes in the graph and when they occurred; and/or the like. In some implementations, the timebar 950 may include a histogram 955 to illustrate overall call volume, compare subsets of call data, and/or the like. Such a histogram may, for example, be utilized to visualize patterns, spikes, and/or the like in overall graph activity; compare trend like activity for selected graph nodes against the full set of data; and/or the like.

FIG. 9B shows an implementation of a QPAV dashboard user interface in which a particular duo of nodes 960 and/or a link associated therewith have been selected. The timebar histogram includes a secondary histogram 965 showing call volume and times for communications associated with the selected nodes.

In some implementations, a geospatial dimension may be overlaid on nodes (e.g., inmates, receivers, and/or the like), such as to allow presentation of related information on one or more maps. This could, for example, facilitate the tracing of criminal activity, communications, and/or the like through a combination of call transcript inspection and geospatial resolution (potentially further including time resolution and/or other call metadata).

In some implementations, a collection of entity types may be extracted from call transcripts (e.g., associating an entity type with each call that references a corresponding entity during the conversation). Such entities could include, but are not limited, Person, Organization, Location, Event, Quantity, Title, Date, Commercial Item, and/or the like. For example, if a particular street name or address is mentioned in multiple calls, an “Address” node may be created and all calls mentioning that address associated therewith (e.g., over a time-based view). In another example, a “Person” name and calls referencing that name may be displayed, colored, highlighted, and/or the like.

In some implementations, network monitoring may be provided. For example, following identification of one or more networks of interest (e.g., in response to a query request), the system may allow for alerts, monitoring, and/or the like to be activated when, e.g., a new node joins and/or joins the network within a certain time period, certain call metadata is identified, a particular structural change occurs in a network of interest, and/or the like. This may be utilized, for example, to monitor networks over time and provide advanced notice of anticipated communications between specific individuals and/or pertaining to specific topics.

In some implementations, networks may be suggested to a user. For example, in one implementation, following identification of one or more networks of interest (e.g., in response to a query request), the system may suggest similar networks. This may be effected, for example, by querying a Graph Database (e.g., storing all call data) via a Graph Querying Language and creating a weighted graph for each of the graphs in the system. Each weighted graph may then be turned into an embedding and stored as a machine-learning (ML) model. Each time a user searches and creates a graph to analyze, the embedding of the current graph may be matched with the ML model based on a similarity score. The graph matches may then be served to the user as suggestions.

### QPAV Controller

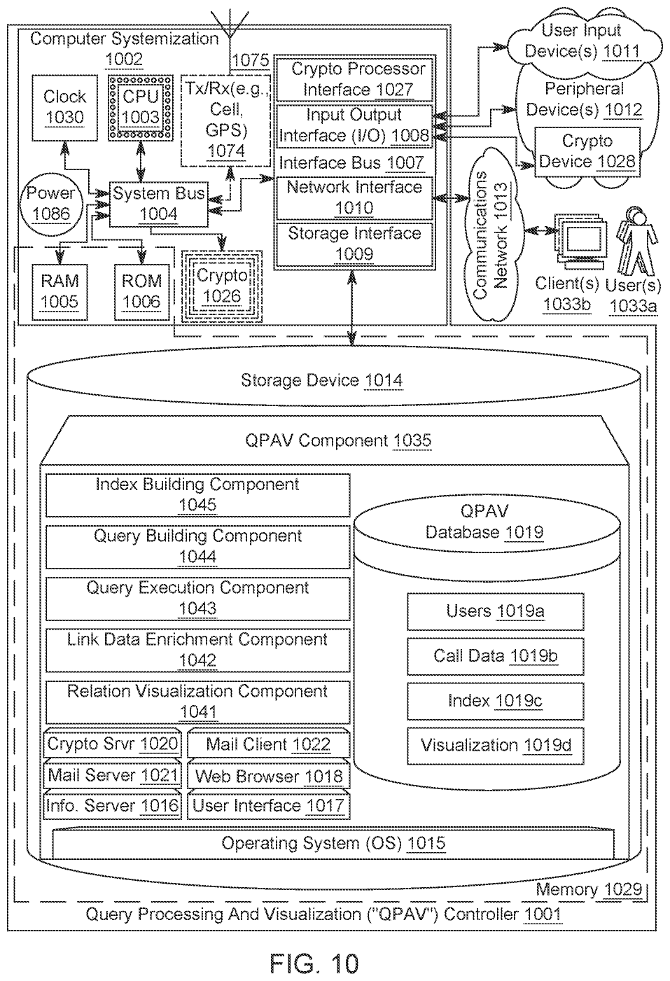

FIG. 10 illustrates inventive aspects of a QPAV controller 1001 in a block diagram. In this embodiment, the QPAV controller 1001 may serve to aggregate, process, store, search, serve, identify, instruct, generate, match, and/or facilitate interactions with a computer through various technologies, and/or other related data.

Typically, users, e.g., 1033a, which may be people and/or other systems, may engage information technology systems (e.g., computers) to facilitate information processing. In turn, computers employ processors to process information; such processors 1003 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 1029 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the QPAV controller 1001 may be connected to and/or communicate with entities such as, but not limited to: one or more users from user input devices 1011; peripheral devices 1012; an optional cryptographic processor device 1028; and/or a communications network 1013. For example, the QPAV controller 1001 may be connected to and/or communicate with users, e.g., 1033a, operating client device(s), e.g., 1033b, including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The QPAV controller 1001 may be based on computer systems that may comprise, but are not limited to, components such as: a computer systemization 1002 connected to memory 1029.

### Computer Systemization

A computer systemization 1002 may comprise a clock 1030, central processing unit (“CPU(s)” and/or “processor(s)” (these terms are used interchangeable throughout the disclosure unless noted to the contrary)) 1003, a memory 1029 (e.g., a read only memory (ROM) 1006, a random access memory (RAM) 1005, etc.), and/or an interface bus 1007, and most frequently, although not necessarily, are all interconnected and/or communicating through a system bus 1004 on one or more (mother)board(s) 1002 having conductive and/or otherwise transportive circuit pathways through which instructions (e.g., binary encoded signals) may travel to effect communications, operations, storage, etc. Optionally, the computer systemization may be connected to an internal power source 1086; e.g., optionally the power source may be internal. Optionally, a cryptographic processor 1026 and/or transceivers (e.g., ICs) 1074 may be connected to the system bus. In another embodiment, the cryptographic processor and/or transceivers may be connected as either internal and/or external peripheral devices 1012 via the interface bus I/O. In turn, the transceivers may be connected to antenna(s) 1075, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing QPAV controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1029 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the QPAV controller and beyond through various interfaces. Should processing requirements dictate a greater amount speed and/or capacity, distributed processors (e.g., Distributed QPAV), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the QPAV may be achieved by implementing a microcontroller such as CAST's R8051XC2 microcontroller; Intel's MCS 51 (i.e., 8051 microcontroller); and/or the like. Also, to implement certain features of the QPAV, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the QPAV component collection (distributed or otherwise) and/or features may be implemented via the microprocessor and/or via embedded components; e.g., via ASIC, coprocessor, DSP, FPGA, and/or the like. Alternately, some implementations of the QPAV may be implemented with embedded components that are configured and used to achieve a variety of features or signal processing.

Depending on the particular implementation, the embedded components may include software solutions, hardware solutions, and/or some combination of both hardware/software solutions. For example, QPAV features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the QPAV features. A hierarchy of programmable interconnects allow logic blocks to be interconnected as needed by the QPAV system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the QPAV may be developed on regular FPGAs and then migrated into a fixed version that more resembles ASIC implementations. Alternate or coordinating implementations may migrate QPAV controller features to a final ASIC instead of or in addition to FPGAs. Depending on the implementation all of the aforementioned embedded components and microprocessors may be considered the “CPU” and/or “processor” for the QPAV.

### Power Source

The power source 1086 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1086 is connected to at least one of the interconnected subsequent components of the QPAV thereby providing an electric current to all subsequent components. In one example, the power source 1086 is connected to the system bus component 1004. In an alternative embodiment, an outside power source 1086 is provided through a connection across the I/O 1008 interface. For example, a USB and/or IEEE 1394 connection carries both data and power across the connection and is therefore a suitable source of power.

### Interface Adapters

Interface bus(ses) 1007 may accept, connect, and/or communicate to a number of interface adapters, conventionally although not necessarily in the form of adapter cards, such as but not limited to: input output interfaces (I/O) 1008, storage interfaces 1009, network interfaces 1010, and/or the like. Optionally, cryptographic processor interfaces 1027 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1009 may accept, communicate, and/or connect to a number of storage devices such as, but not limited to: storage devices 1014, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1010 may accept, communicate, and/or connect to a communications network 1013. Through a communications network 1013, the QPAV controller is accessible through remote clients 1033b (e.g., computers with web browsers) by users 1033a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed QPAV), architectures may similarly be employed to pool, load balance, and/or otherwise increase the communicative bandwidth required by the QPAV controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1010 may be used to engage with various communications network types 1013. For example, multiple network interfaces may be employed to allow for the communication over broadcast, multicast, and/or unicast networks.

Input Output interfaces (I/O) 1008 may accept, communicate, and/or connect to user input devices 1011, peripheral devices 1012, cryptographic processor devices 1028, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1011 often are a type of peripheral device 1012 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 1012 may be connected and/or communicate to I/O and/or other facilities of the like such as network interfaces, storage interfaces, directly to the interface bus, system bus, the CPU, and/or the like. Peripheral devices may be external, internal and/or part of the QPAV controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 1028), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the QPAV controller may be embodied as an embedded, dedicated, and/or monitor-less (i.e., headless) device, wherein access would be provided over a network interface connection.

Cryptographic units such as, but not limited to, microcontrollers, processors 1026, interfaces 1027, and/or devices 1028 may be attached, and/or communicate with the QPAV controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1029. However, memory is a fungible technology and resource, thus, any number of memory embodiments may be employed in lieu of or in concert with one another. It is to be understood that the QPAV controller and/or a computer systemization may employ various forms of memory 1029. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 1029 will include ROM 1006, RAM 1005, and a storage device 1014. A storage device 1014 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 1029 may contain a collection of program and/or database components and/or data such as, but not limited to: operating system component(s) 1015 (operating system); information server component(s) 1016 (information server); user interface component(s) 1017 (user interface); Web browser component(s) 1018 (Web browser); database(s) 1019; mail server component(s) 1021; mail client component(s) 1022; cryptographic server component(s) 1020 (cryptographic server); the QPAV component(s) 1035; and/or the like (i.e., collectively a component collection). These components may be stored and accessed from the storage devices and/or from storage devices accessible through an interface bus. Although non-conventional program components such as those in the component collection, typically, are stored in a local storage device 1014, they may also be loaded and/or stored in memory such as: peripheral devices, RAM, remote storage facilities through a communications network, ROM, various forms of memory, and/or the like.

### Operating System

The operating system component 1015 is an executable program component facilitating the operation of the QPAV controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the QPAV controller to communicate with other entities through a communications network 1013. Various communication protocols may be used by the QPAV controller as a subcarrier transport mechanism for interaction, such as, but not limited to: multicast, TCP/IP, UDP, unicast, and/or the like.

### Information Server

An information server component 1016 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the QPAV controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/my Information.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the QPAV database 1019, operating systems, other program components, user interfaces, Web browsers, and/or the like.

Access to the QPAV database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the QPAV. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the QPAV as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1017 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1018 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the QPAV enabled nodes. The combined application may be nugatory on systems employing standard Web browsers.

### Mail Server

A mail server component 1021 is a stored program component that is executed by a CPU 1003. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the QPAV.

Access to the QPAV mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1022 is a stored program component that is executed by a CPU 1003. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1020 is a stored program component that is executed by a CPU 1003, cryptographic processor 1026, cryptographic processor interface 1027, cryptographic processor device 1028, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the QPAV may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the QPAV component to engage in secure transactions if so desired. The cryptographic component facilitates the secure accessing of resources on the QPAV and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The QPAV Database

The QPAV database component 1019 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the QPAV database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the QPAV database is implemented as a data-structure, the use of the QPAV database 1019 may be integrated into another component such as the QPAV component 1035. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1019 includes several tables 1019a-d. A User table 1019a may include fields such as, but not limited to: user_ID, name, login, password, contact_info, query_history, settings, preferences, and/or the like. The User table may support and/or track multiple entity accounts on a QPAV. A Call Data table 1019b may include fields such as, but not limited to: call_data_ID, call_ID, caller_ID, caller_name, caller_status, caller_telephone, site_ID, station, area_code, call_transcript, call_metadata, and/or the like. An Index table 1019c may include fields such as, but not limited to: index_ID, call_data_ID, call_ID, caller_ID, index_type; transcript_terms; call_metadata; and/or the like. A Visualization table 1019d may include fields such as, but not limited to: graph_ID; graph_type; user_ID; call_data_ID; call_ID; caller_ID; and/or the like.

In one embodiment, the QPAV database may interact with other database systems. For example, employing a distributed database system, queries and data access by search QPAV component may treat the combination of the QPAV database, an integrated data security layer database as a single database entity.

In one embodiment, user programs may contain various user interface primitives, which may serve to update the QPAV. Also, various accounts may require custom database tables depending upon the environments and the types of clients the QPAV may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1019a-d. The QPAV may be configured to keep track of various settings, inputs, and parameters via database controllers.

The QPAV database may communicate to and/or with other components in a component collection, including itself, and/or facilities of the like. Most frequently, the QPAV database communicates with the QPAV component, other program components, and/or the like. The database may contain, retain, and provide information regarding other nodes and data.

### The QPAVs

The QPAVcomponent 1035 is a stored program component that is executed by a CPU. In one embodiment, the QPAV component incorporates any and/or all combinations of the aspects of the QPAV discussed in the previous figures. As such, the QPAV affects accessing, obtaining and the provision of information, services, transactions, and/or the like across various communications networks. The features and embodiments of the QPAV discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the QPAV's features and facilities, and in many cases reduce the costs, energy consumption/requirements, and extend the life of QPAV's underlying infrastructure; this has the added benefit of making the QPAV more reliable. Similarly, many of the features and mechanisms are designed to be easier for users to use and access, thereby broadening the audience that may enjoy/employ and exploit the feature sets of the QPAV; such ease of use also helps to increase the reliability of the QPAV. In addition, the feature sets include heightened security as noted via the Cryptographic components 1020, 1026, 1028 and throughout, making access to the features and data more reliable and secure.

The QPAV component transforms raw data, query, and, UI interaction inputs via QPAV relation visualization 1041; link data enrichment 1042; query execution 1043; query building 1044; and index building 1045 components into query result outputs, call networks and/or graphs, call activity insights, user interface displays, and/or the like.

The QPAV component enabling access of information between nodes may be developed by employing standard development tools and languages such as, but not limited to: Apache components, Assembly, ActiveX, binary executables, (ANSI) (Objective-) C (++), C# and/or NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the QPAV server employs a cryptographic server to encrypt and decrypt communications. The QPAV component may communicate to and/or with other components in a component collection, including itself, and/or facilities of the like. Most frequently, the QPAV component communicates with the QPAV database, operating systems, other program components, and/or the like. The QPAV may contain, communicate, generate, obtain, and/or provide program component, system, user, and/or data communications, requests, and/or responses.

### Distributed QPAVs

The structure and/or operation of any of the QPAV node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the QPAV controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1
where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the QPAV controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header(‘Content-Type: text/plain’);

| | |
|---|---|
| // | set ip address and port to listen to for incoming data |

$address = ‘192.168.0.100’;
$port = 255;

| | |
|---|---|
| // | create a server-side SSL socket, listen for/accept incoming |
| | communication |

$sock = socket_create(AF_INET, SOCK_STREAM, 0);
socket_bind($sock, $address, $port) or die(‘Could not bind to

address’);

socket_listen($sock);
$client = socket_accept($sock);

| | |
|---|---|
| // | read input data from client device in 1024 byte blocks until end of |
| | message |
| do | { |
| | $input = “”; |
| | $input = socket_read($client, 1024); |
| | $data .= $input; |
| } | while($input != “”); |
| // | parse data to extract variables |
| | $obj = json_decode($data, true); |
| // | store input data in a database |

mysql_connect(“201.408.185.132”,$DBserver,$password); // access

database server

mysql_select(“CLIENT_DB.SQL”); // select database to append
mysql_query(“INSERT INTO UserTable (transmission)
VALUES ($data)”); // add data to UserTable table in a CLIENT database
mysql_close(“CLIENT_DB.SQL”); // close connection to database
?>

Also, the following resources may be used to provide example embodiments regarding SOAP parser implementation:
http://www.xav.com/perl/site/lib/SOAP/Parser.html http://publib.boulder.ibm.com/infocenter/tivihelp/v2r1/index.jsp?topic=/com.ibm.IBMDI.doc/referenceguide295.htm
   and other parser implementations:
http://publib.boulder.ibm.com/infocenter/tivihelp/v2r1/index.jsp?topic=/com.ibm.IBMDI.doc/referenceguide259.htm
   all of which are hereby expressly incorporated by reference.

In order to address various issues and advance the art, the entirety of this application for QUERY PROCESSING AND VISUALIZATION APPARATUSES, METHODS AND SYSTEMS (including the Cover Page, Title, Headings, Field, Background, Summary, Brief Description of the Drawings, Detailed Description, Claims, Abstract, Figures, Appendices and/or otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs and/or characteristics of a QPAV individual and/or enterprise user, database configuration and/or relational model, data type, data transmission and/or network framework, syntax structure, and/or the like, various embodiments of the QPAV may be implemented that enable a great deal of flexibility and customization. For example, aspects of the QPAV may be adapted for analysis of call center communications, social media and/or other electronic publications, workplace communications, and/or the like. While various embodiments and discussions of the QPAV have been directed to efficient data collection, storage, and evaluation, however, it is to be understood that the embodiments described herein may be readily configured and/or customized for a wide variety of other applications and/or implementations.

What is claimed is:

1. A processor-implemented method, comprising:
receiving a query via a user interface, the query comprising at least one query token corresponding to unstructured telephone call information;
searching a datastore based on the at least one query token to recover a plurality of call records corresponding to the at least one query token;
enhancing link information for each of the plurality of call records based on associated metadata;
preparing a graph comprising nodes and links, wherein each of the nodes corresponds to at least one caller identifier and each of the links corresponds to one of the plurality of call records; and
providing the graph for display via the user interface.

2. The method of claim 1, further comprising:
acquiring the plurality of call records, each call record including a call transcription and the metadata;
generating a searchable index for searching the datastore, the searchable index being based on the call transcription and the metadata for each of the plurality of call records; and
storing the searchable index.

3. The method of claim 1, wherein enhancing link information further comprises enhancing temporal information associated with the link.

4. The method of claim 1, wherein enhancing link information further comprises enhancing spatial information associated with the link.

5. The method of claim 1, further comprising:
providing at least one visualization control via a user interface, the visualization control operative to change the display of the graph.

6. The method of claim 5, wherein the visualization control is operative to cluster the nodes of the graph according to at least one relationship between the plurality of call records.

7. The method of claim 5, wherein the visualization control is operative to identify most active links in the graph.

8. The method of claim 5, wherein the visualization control is operative to identify network gatekeepers in the graph.

9. The method of claim 5, wherein the visualization control is operative to identify a set of most-connected nodes in the graph.

10. The method of claim 5, wherein the visualization control is operative to determine PageRank associated with the nodes in the graph.

11. The method of claim 5, wherein the visualization control is operative to determine popularity associated with the nodes in the graph.

12. The method of claim 5, wherein the visualization control is operative to generate an organic visualization of the graph.

13. The method of claim 5, wherein the visualization control is operative to generate a lens visualization of the graph.

14. The method of claim 5, wherein the visualization control is operative to generate a structural visualization of the graph.

15. The method of claim 1, wherein the graph is provided for display in association with a time bar.

16. The method of claim 15, wherein the time bar displays times associated with the plurality of call records.

17. The method of claim 16, wherein the time bar includes an interactive slider that selects a range of times with which to restrict the plurality of call records.

18. The method of claim 1, wherein the graph is configured to provide call transcription information associated with a given link upon selection of that link via the user interface.

19. The method of claim 1, wherein the unstructured telephone call information comprises one or more words in a call transcript.

20. An apparatus, comprising:
a processor;
a memory communicatively coupled to the processor and storing program instructions that, when executed, cause the processor to:
receive a query via a user interface, the query comprising at least one query token corresponding to unstructured telephone call information;
search a datastore based on the at least one query token to recover a plurality of call records corresponding to the at least one query token;
enhance link information for each of the plurality of call records based on associated metadata;
prepare a graph comprising nodes and links, wherein each of the nodes corresponds to at least one caller identifier and each of the links corresponds to one of the plurality of call records; and
provide the graph for display via the user interface.

21. A processor-accessible, non-transitory medium storing processor-issuable program instructions, comprising:
receive a query via a user interface, the query comprising at least one query token corresponding to unstructured telephone call information;
search a datastore based on the at least one query token to recover a plurality of call records corresponding to the at least one query token;
enhance link information for each of the plurality of call records based on associated metadata;
prepare a graph comprising nodes and links, wherein each of the nodes corresponds to at least one caller identifier and each of the links corresponds to one of the plurality of call records; and
provide the graph for display via the user interface.
